(19) United States
(12) Patent Application Publication
(10) Pub. No.: US 2015/0353371 A1
(43) Pub. Date: Dec. 10, 2015

(54) PROCESSES FOR PRODUCING HYDROGEN CYANIDE USING STATIC MIXER

(71) Applicants: John C. CATON, Yoakum, TX (US); David W. RABENALDT, Port Lavaca, TX (US); William A. McKNIGHT, Victoria, TX (US)

(72) Inventors: John C. CATON, Yoakum, TX (US); David W. RABENALDT, Port Lavaca, TX (US); William A. McKNIGHT, Victoria, TX (US)

(73) Assignee: INVISTA NORTH AMERICA S.A R.L., Wilmington, DE (US)

(21) Appl. No.: 14/742,086

(22) PCT Filed: Dec. 12, 2013
(86) PCT No.: PCT/US2013/074535

§ 371 Date: Jun. 17, 2015

Related U.S. Application Data
(60) Provisional application No. 61/738,657, filed on Dec. 18, 2012.

(51) Int. Cl. C01C 3/02; B23K 28/00; B01F 15/00

(52) U.S. Cl. CPC C01C 3/0225; C01C 3/0212; B01F 15/00922; B23K 28/00

(57) ABSTRACT

A static mixer is disclosed for a hydrogen cyanide reaction process that thoroughly mixes the reactant gases to form a ternary gas mixture that has a coefficient of variation of less than 0.1 across the diameter of the catalyst bed. The static mixer comprises tabs that are inserted through non-continuous slots in the conduit and the tabs are secured to the external wall of the conduit.

### CROSS REFERENCE TO RELATED APPLICATION

This application claims priority to U.S. App. No. 61/738,657, filed Dec. 18, 2012, the entire contents and disclosures of which are incorporated herein.

### FIELD OF THE INVENTION

The present invention relates to a process for producing hydrogen cyanide and more particularly, to a static mixer for producing a thoroughly mixed ternary gas that is contacted with a catalyst, and to processes for using the static mixer and manufacturing the same.

### BACKGROUND OF THE INVENTION

Conventionally, hydrogen cyanide (“HCN”) is produced on an industrial scale according to either the Andrussow process or the BMA process. (See e.g., Ullman's Encyclopedia of Industrial Chemistry, Volume A8, Weinheim 1987, pages 161-163). For example, in the Andrussow process, HCN can be commercially produced by reacting ammonia with a methane-containing gas and an oxygen-containing gas at elevated temperatures in a reactor in the presence of a suitable catalyst (U.S. Pat. Nos. 1,934,838 and 6,596,251). Sulfur compounds and higher homologues of methane may have an effect on the parameters of oxidative ammonolysis of methane. See, e.g., Trusov, Effect of Sulfur Compounds and Higher Homologues of Methane on Hydrogen Cyanide Production by the Andrussow Method, Russian J. Applied Chemistry, 74:10 (2001), pp. 1693-1697). Unreacted ammonia is separated from HCN by contacting the reactor effluent gas stream with an aqueous solution of ammonium phosphate in an ammonia absorber. The separated ammonia is purified and concentrated for recycle to HCN conversion. HCN is recovered from the treated reactor effluent gas stream typically by absorption into water. The recovered HCN may be treated with further refining steps to produce purified HCN. Clean Development Mechanism Project Design Document Form (CDM PDD, Version 3), 2006, schematically explains the Andrussow HCN production process. Purified HCN can be used in hydrocyanation, such as hydrocyanation of an olefin-containing group, or such as hydrocyanation of 1,3-butadiene and pentenenitrile, which can be used in the manufacture of adiponitrile (“ADN”). In the BMA process, HCN is synthesized from methane and ammonia in the substantial absence of oxygen and in the presence of a platinum catalyst, resulting in the production of HCN, hydrogen, nitrogen, residual ammonia, and residual methane. (See e.g., Ullman's Encyclopedia of Industrial Chemistry, Volume A8, Weinheim 1987, pages 161-163). Commercial operators require process safety management to handle the hazardous properties of hydrogen cyanide. (See Maxwell et al. Assuring process safety in the transfer of hydrogen cyanide manufacturing technology, JHazMat 142 (2007), 677-684). Additionally, emissions of HCN production processes from production facilities may be subject to regulations, which may affect the economics of HCN manufacturing. (See Crump, Economic Impact Analysis For The Proposed Cyanide Manufacturing NESHAP, EPA, May 2000).

In producing HCN, the ammonia gas, methane-containing gas and oxygen-containing gas are mixed to form a ternary gas mixture that is fed to the reactor. Because the HCN process involves several reactive gases, the mixing of these reactive gases prior to being contacted with the catalyst may be beneficial. However, when carrying out the prior mixing of the reactive gases, the risks associated with the reactivity of the gases may become apparent. U.S. Pat. No. 2,803,522 discloses a mixer for the oxygen-containing gas and ammonia. U.S. Pat. No. 3,063,803 discloses a detachable mounted gas mixing chamber connected to the reactor. U.S. Pat. No. 3,215,495 discloses an internal baffle within the gas mixing chamber to mix the reactant gases. An internal baffle may be associated with a relatively high pressure drop. More recently, it has been proposed to place the mixing chamber within the reactor as described in US Pub. No. 2011/0171101. This configuration requires a gas permeable layer and several mixing plates within the reactor.

These previous mixing chambers for HCN production are insufficient for producing a thoroughly mixed ternary gas and thus lead to productivity losses and increased separation of the reactant gases from the HCN.

U.S. Pat. No. 8,133,458 discloses a reactor for converting methane, ammonia and oxygen and alkaline or alkaline earth hydroxides into alkaline or alkaline earth cyanides by two-stage reactions comprising a first stage with a gas inlet, wherein the first stage is formed by a cone with distribution plates providing an even gas distribution over the catalyst material wherein the distribution plates are located between the gas inlet of the reactor and catalyst material and the distribution plates being perforated with a number of holes, with the distribution plates spaced from each other in the flow direction of the gas, the first distribution plate(s) functioning mainly to distribute the gas, whereas the last distribution plate works as a heat radiation shield and as a distribution plate facing the catalyst material, and wherein the catalyst material is present in the form of catalyst gauze fixed by catalyst weights.

Other static mixers have been used to mix reactant gases. U.S. Pat. No. 4,929,088 discloses a static mixing device adapted to be inserted in a fluid stream having a main flow direction with respect to a closed conduit, comprising at least two tabs inclined in the flow direction at a preselected elevation angle between 10° and 45° to the surface of the conduit. U.S. Pat. No. 6,000,841 discloses a static mixer conduit that comprises a longitudinally elongated conduit having tabs that are arranged with respective first edges adjacent the conduit wall and respective opposed second edges that are spaced radially inward from the conduit wall. Generally, static mixers are sufficient to pass a fluid stream while maintaining a relatively flat velocity profile associated with turbulent flow but are difficult to install and maintain.

Thus, what is needed is improved mixing of the reactant gases suitable for HCN production that is also easy to install and maintain.

### SUMMARY OF THE INVENTION

In a first embodiment, the present invention is directed to a reaction assembly for preparing hydrogen cyanide comprising: (a) a mixing vessel comprising an elongated conduit having an outlet located at a proximal end of the elongated conduit, a first inlet port and a second inlet port each for introducing at least one reactant gas selected from the group consisting of a methane-containing gas, an ammonia-containing gas, an oxygen-containing gas, and mixtures thereof, into the mixing vessel, wherein the second inlet port is downstream of the first inlet port, a first static mixing zone comprising one or more first rows of non-continuous slots through which one or more corresponding tabs are inserted and secured to an external surface of the elongated conduit, and wherein the first static mixing zone is adjacent to the first inlet port, a second static mixing zone comprising one or more second rows of non-continuous slots through which one or more corresponding tabs are inserted and secured to the external surface of the elongated conduit, and wherein the second static mixing zone is adjacent to the second inlet port, wherein each corresponding tab has an upstream face that is angled in the flow direction, wherein the first and second static mixing zones provide cross-stream mixing of the at least one reactant gas to produce a ternary gas; and (b) a reactor vessel comprising a reactor inlet that is operatively coupled to the outlet to receive the ternary gas mixture, and a catalyst bed containing a catalyst for producing a hydrogen cyanide stream. The number of rows in the first static mixing zone may be from one to ten and the number of rows in the second static mixing zone may be from one to ten. Each of the first rows and second rows may contain from one to ten of the non-continuous slots. The number of rows in the second static mixing zone may be greater than or equal to the number of rows in the first static mixing zone. The corresponding tabs may have an angle from an internal wall of the conduit from 5° to 45°. The reaction assembly may further comprise one or more flow straighteners located upstream of the first static mixing zone for aligning the flow of the at least one reactant gas, wherein the one or more flow straighteners each have a center body. The reaction assembly may further comprise one or more flow straighteners located upstream of the second static mixing zone for aligning the flow of the at least one reactant gas, wherein the one or more flow straighteners each have a center body. The non-continuous slots may be an I-shape, I-shape, T-shape, U-shape, or V-shape. The non-continuous slots of two or more first rows may be transversely aligned. The non-continuous slots of two or more second rows may be transversely aligned. Each of the corresponding tabs within the elongated conduit may be non-parallel to the flow direction. Each of the corresponding tabs may have a trailing edge having an angle from 30° to 90°. Each of the corresponding tabs may have a degree of cant from 0° to 7°. Each of the corresponding tabs may have a surface area from 50 to 250 cm². Each of the corresponding tabs may comprise 310SS S or 316SS.

A second embodiment of the present invention is directed to a reaction assembly for preparing hydrogen cyanide comprising (a) a mixing vessel comprising an elongated conduit having an outlet located at a proximal end of the elongated conduit, a first inlet port and a second inlet port each for introducing at least one reactant gas selected from the group consisting of a methane-containing gas, an ammonia-containing gas, an oxygen-containing gas, and mixtures thereof, into the mixing vessel, wherein the second inlet port is proximal to the first inlet port, a first static mixing zone comprising one or more first rows of non-continuous slots through which one or more corresponding tabs at having a first angle are inserted and secured to an external surface of the elongated conduit, and wherein the first static mixing zone is adjacent to the first inlet port, a second static mixing zone comprising one or more second rows of non-continuous slots through which one or more corresponding tabs having a second angle are inserted and secured to the external surface of the elongated conduit, and wherein the second static mixing zone is adjacent to the second inlet port and/or proximal to the second inlet port, wherein the first angle is different than the second angle, wherein the first and second static mixing zones provide cross-stream mixing of the at least one reactant gas to produce a ternary gas; and (b) a reactor vessel comprising a reactor inlet that is operatively coupled to the outlet to receive the ternary gas mixture, and a catalyst bed containing a catalyst for producing a hydrogen cyanide stream. The first angle and the second angle may be from 5° to 45°. The first angle is 30° and may be larger than the second angle. The first angle is 30° and may be less than the second angle.

A third embodiment of the present invention is directed to a process for producing hydrogen cyanide, comprising: introducing a methane-containing gas, an ammonia-containing gas, and an oxygen-containing gas into an elongated conduit to produce a ternary gas mixture, the elongated conduit comprising one or more static mixing zones having at least one non-continuous slot through which a tab is inserted and secured to an external surface of the elongated conduit; and contacting the ternary gas mixture with a catalyst in a catalyst bed to provide a reaction product comprising hydrogen cyanide. The step of introducing may comprise: mixing the methane-containing gas and the ammonia-containing gas in a first static mixing zone comprising one or more first rows of the non-continuous slots to form a binary gas mixture; and mixing the oxygen-containing gas with the binary gas mixture in a second static mixing zone to form the ternary gas mixture, wherein the second static mixing zone comprises one or more second rows of the non-continuous slots. The ternary gas mixture may have a coefficient of variation of less than 0.1 across the diameter of the catalyst bed, preferably less than 0.05 across the diameter of the catalyst bed. The process may further comprise passing the methane-containing gas, the ammonia-containing gas, or the oxygen-containing gas across a flow straightener prior to the one or more static mixing zones, wherein the flow straightener has a center body. The tab, once inserted, may have an angle from an internal wall of the conduit from 5° to 45°. The conduit may have from 4 to 24 non-continuous slots. The non-continuous slots may be in I-shape, I-shape, T-shape, U-shape, or V-shape. The tab may be secured to the non-continuous slot by a weld joint formed on the external surface of the conduit. The pressure drop in the elongated conduit may be less than 35 kPa. The tab may have a degree of cant from 0° to 7°. The tab may have a rigidity to retain an angle upon a pressure change in the elongated conduit. The process of any of the ternary gas mixture may comprise at least 25 vol. % oxygen. The ternary gas mixture may have a molar ratio of ammonia-to-oxygen from 1.2 to 1.6 and a molar ratio of methane-to-oxygen from 1 to 1.25. The mixing vessel may operate at a temperature from 50° C. to 120° C. In some aspects, there is no weld or adhesive provided from the internal cavity to secure the tab.

A fourth embodiment of the present invention is directed to a process for producing hydrogen cyanide, comprising introducing into an elongated conduit via a first inlet port at least one reactant gas selected from the group consisting of a methane-containing gas, an ammonia-containing gas, and mixtures thereof; mixing the reactant gases in a first static mixing zone comprising one or more first rows of non-continuous slots through which one or more corresponding tabs are inserted and secured to an external surface of the elongated conduit; introducing into an elongated conduit via a second inlet port an oxygen-containing gas; mixing oxygen-containing gas with the reactant gases in a second static mixing zone to form a ternary gas mixture, wherein the second static mixing zone comprises one or more second rows of non-continuous slots through which one or more corresponding tabs are inserted and secured to the external surface of the elongated conduit; and reacting the ternary gas mixture in the presence of a catalyst to form a hydrogen cyanide stream. The ternary gas mixture may comprise at least 25 vol. % oxygen. Each corresponding tab may have an upstream face that is angled in the flow direction of the ternary gas mixture. The corresponding tab may have an angle from 5° to 45°. The mixing vessel may be configured to provide the ternary gas mixture having a coefficient of variation of less than 0.1 across the diameter of the catalyst bed. The pressure drop in the mixing vessel may be less than 35 kPa. The non-continuous slots may be in I-shape, I-shape, T-shape, U-shape, or V-shape. The ternary gas mixture may have a molar ratio of ammonia-to-oxygen from 1.2 to 1.6. The ternary gas mixture may have a molar ratio of ammonia-to-methane from 1 to 1.5. The ternary gas mixture may have a molar ratio of methane-to-oxygen from 1 to 1.25. Each of the corresponding tabs may have a trailing edge having an angle from 30° to 90°.

A fifth embodiment of the present invention is directed to a process for manufacturing a mixing vessel comprising: providing one or more tabs having an angled upstream surface having a bevel edge, downstream surface, and a support on the downstream surface, wherein the support has a shape that is selected from the group consisting of an I-shape, I-shape, T-shape, U-shape, and V-shape and extends past the plane of the upstream surface and providing an elongated conduit having an internal cavity, a first inlet port, and an outlet port that is connected to a reactor vessel. The process comprises cutting one or more non-continuous slots through the elongated conduit downstream of the first inlet port, wherein the non-continuous slots correspond to the shape of the support; inserting one of the one or more tabs into one of the one or more non-continuous slots from the internal cavity by slidably engaging the support into the non-continuous slots and abutting the bevel edge against the internal surface of the elongated conduit upstream of the one or more non-continuous slots; and securing the support to the outer surface of the elongated conduit. The support may be secured by welding to the outer surface. In one embodiment, a chamfer is ground out on the outer surface of the elongated conduit where the one or more non-continuous slots are cut. Preferably there is no weld or adhesive provided from the internal cavity to secure the one or more tabs.

A sixth embodiment of the present invention is directed to a process for manufacturing a mixing vessel comprising providing one or more tabs having an angled upstream surface having a bevel edge, downstream surface, and a support on the downstream surface, wherein the support has a shape and extends past the plane of the upstream surface, and providing an elongated conduit having an internal cavity, a first inlet port, a second inlet and an outlet port that is connected to a reactor vessel. The process for comprises cutting at least one row of one or more first non-continuous slots through the elongated conduit downstream of the first inlet port, wherein the first non-continuous slots correspond to the shape of the support; cutting at least one row of one or more second non-continuous slots through the elongated conduit downstream of the second inlet port, wherein the second non-continuous slots correspond to the shape of the support; inserting one of the one or more tabs into one of the one or more first and second non-continuous slots from the internal cavity by slidably engaging the support into the first and second non-continuous slots and abutting the bevel edge against the internal surface of the elongated conduit upstream of the one or more first and second non-continuous slots; and securing the support to the outer surface of the elongated conduit.

### BRIEF DESCRIPTION OF THE DRAWINGS

FIG. 1 is a simplified schematic flow diagram of an HCN synthesis system according to an embodiment of the presently claimed invention.

FIG. 2 is cross-sectional view of a mixing vessel according to an embodiment of the presently claimed invention.

FIG. 3 is a detailed cross-sectional view a tab inserted in the mixing vessel according to an embodiment of the presently claimed invention.

FIGS. 4A-4C are views of a tab according to an embodiment of the presently claimed invention.

FIG. 5 is a simplified schematic flow diagram of an HCN synthesis system having a reactant feed stream purification according to an embodiment of the presently claimed invention.

### DETAILED DESCRIPTION OF THE INVENTION

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, group of elements, components, and/or groups thereof.

Language such as “including,” “comprising,” “having,” “containing,” or “involving,” and variations thereof, is intended to be broad and encompass the subject matter listed thereafter, as well as equivalents, and additional subject matter not recited. Further, whenever a composition, a group of elements, process or method steps, or any other expression is preceded by the transitional phrase “comprising,” “including,” or “containing,” it is understood that it is also contemplated herein the same composition, group of elements, process or method steps or any other expression with transitional phrases “consisting essentially of,” “consisting of,” or “selected from the group of consisting of,” preceding the recitation of the composition, the group of elements, process or method steps or any other expression.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment(s) was/were chosen and described in order to best explain the principles of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

Reference will now be made in detail to certain disclosed subject matter. While the disclosed subject matter will be described in conjunction with the enumerated claims, it will be understood that they are not intended to limit the disclosed subject matter to those claims. On the contrary, the disclosed subject matter is intended to cover all alternatives, modifications, and equivalents, which can be included within the scope of the presently disclosed subject matter as defined by the claims.

Hydrogen cyanide (“HCN”) is produced on an industrial scale according to either the Andrussow process or by the BMA process. In the Andrussow process, methane, ammonia and oxygen-containing raw materials are reacted at temperatures above 1000° C. in the presence of a catalyst to produce a crude hydrogen cyanide product comprising HCN, hydrogen, carbon monoxide, carbon dioxide, nitrogen, residual ammonia, residual methane, and water. Natural gas is typically used as the source of methane while air, oxygen-enriched air, or pure oxygen can be used as the source of oxygen. The catalyst is typically a wire mesh platinum/rhodium alloy or a wire mesh platinum/iridium alloy. Other catalyst compositions can be used and include, but are not limited to, a platinum group metal, platinum group metal alloy, supported platinum group metal or supported platinum group metal alloy. Other catalyst configurations can also be used and include, but are not limited to, porous structures, wire gauze, tablets, pellets, monoliths, foams, impregnated coatings, and wash coatings. In the BMA process, methane and ammonia are reacted using a platinum catalyst as described in U.S. Pat. No. 7,429,370 and incorporated by reference herein.

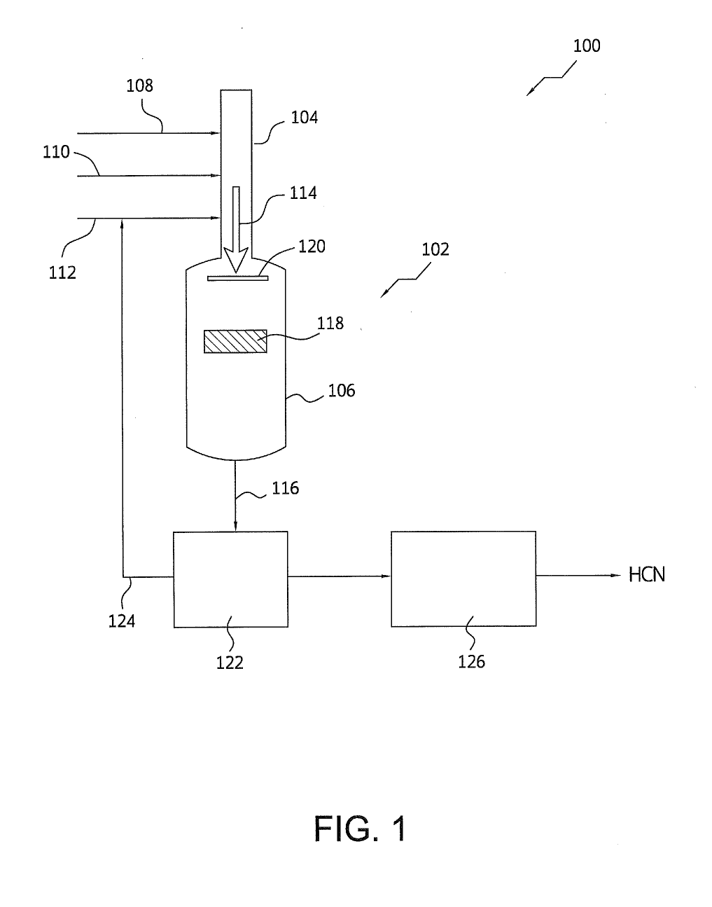

In general, FIG. 1 shows a HCN synthesis system 100. Generally, the HCN is produced in a reaction assembly 102 that includes a mixing vessel 104 and a reactor vessel 106. In the Andrussow process, the reactant gases, which include an oxygen-containing gas feed stream 108, a methane-containing gas feed stream 110, and an ammonia-containing gas feed stream 112, are introduced into the mixing vessel 104. It is noted that the feed locations shown in FIG. 1 are schematic and are not intended to show an order for feeding the reactants to the mixing vessel 104. In some embodiments, methane-containing gas feed stream 110 and ammonia-containing gas feed stream 112 may be combined prior to being introduced to mixing vessel 104. In the BMA process, the reactant gases include a methane-containing gas feed stream 110, and an ammonia-containing gas feed stream 112 which are introduced into the mixing vessel 104. In one embodiment, mixing vessel 104 may contain one or more static mixing zones for producing a thoroughly mixed ternary gas mixture 114.

Ternary gas mixture 114 exits mixing vessel 104 and contacts a catalyst contained within reactor vessel 106 to form a crude hydrogen cyanide product 116 containing HCN. The catalyst may be within a catalyst bed 118. In one embodiment, a distributor plate 120 may be used to convey ternary gas mixture 114 into reactor vessel 106. Distributor plate 120 may also be used to evenly distribute the ternary gas mixture and further mix the ternary gas mixture as needed. Ammonia can be recovered from crude hydrogen cyanide product 116 in an ammonia recovery section 122 and be returned via line 124. The HCN can be further refined in an HCN refining section 126 to a purity required for the desired use. In some embodiments, the HCN may be a high purity HCN containing less than 100 ppm by weight water.

A thoroughly mixed ternary gas for the purposes of the present invention has a coefficient of variation (CoV) that is less than 0.1 across the diameter of the catalyst bed, or preferably less than 0.05 and more preferably less than 0.01. In terms of ranges, the CoV may be from 0.001 to 0.1, or preferably from 0.001 to 0.05. Low CoV beneficially increases the productivity of reactants being converted to HCN. CoV is defined as the ratio of the standard deviation, σ, to the mean, μ. Ideally, CoV would be as low as possible, for example less than 0.1, for example, 0.05. The HCN unit may operate above a CoV of 0.1, and a CoV of 0.2 is not unusual, i.e. ranging from 0.01 to 0.2 or from 0.02 to 0.15. However, at a CoV above 0.1, the operating cost is higher and HCN yield is lower, for example 2% to 7% lower, translating into a lost opportunity of millions of dollars per year in continuous commercial operation. A thoroughly mixed ternary gas advantageously increases the productivity of HCN and returns higher yields of HCN. Performance improvement can be obtained by achieving a substantially uniform bed temperature across the catalyst bed.

When CoV exceeds 0.1, the reactant gases may be in concentrations that are outside of the safe operating ranges for the catalyst bed. For example, when operating at higher oxygen concentrations in the ternary gas, a larger CoV may create an increase in oxygen that results in a flashback. In addition, when CoV is larger, the catalyst bed may be exposed to more methane, which may lead to a buildup of carbon deposits. The carbon deposits may decrease catalyst life and performance. Thus, there may be a higher raw material requirement with larger CoV.

The mixing vessel may be operated at a temperature from 50° C. to 120° C. Higher temperatures may be used in the mixing vessel with preheating of the reactant gases as described herein. In one embodiment, it is preferred that the mixing vessel is operated below the temperature of the reactor vessel. The operating pressure of the mixing vessel may vary widely from 130 kPa to 400 kPa, and more preferably from 130 to 300 kPa. Unless otherwise indicated as gauge, all pressures are absolute. In general, the mixing vessel may operate at a similar pressure as the reactor vessel.

The reactant gases are mixed under conditions that minimize the pressure drop within the mixing vessel. In one embodiment, the pressure drop in the mixing vessel is less than 35 kPa, preferably less than 25 kPa. Minimizing the pressure drop may reduce the maximum pressure of the ternary gas mixture and thus reduce potential pressure in the event of a detonation. Reducing the pressure drop also minimizes the energy associated with mixing (i.e., compression energy).

The reactant gases are supplied to a mixing vessel to provide a ternary gas mixture having a molar ratio of ammonia-to-oxygen from 1.2 to 1.6, e.g., from 1.3 to 1.5, a molar ratio of ammonia-to-methane from 1 to 1.5, e.g., from 1.1 to 1.45 and a molar ratio of methane-to-oxygen from 1 to 1.25, e.g., from 1.05 to 1.15. For example, a ternary gas mixture may have a molar ratio of ammonia-to-oxygen of 1.3 and methane-to-oxygen 1.2. In another exemplary embodiment, the ternary gas mixture may have a molar ratio of ammonia-to-oxygen of 1.5 and methane-to-oxygen of 1.15. The oxygen concentration in the ternary gas mixture may vary depending on these molar ratios. Thus, in some embodiments, the ternary gas mixture comprises at least 25 vol. % oxygen, e.g., at least 28 vol. % oxygen. In some embodiments, the ternary gas mixture comprises from 25 to 32 vol. % oxygen, e.g., from 26 to 30 vol. % oxygen. Various control systems may be used to regulate the reactant gas flow. For example, flow meters that measure the flow rate, temperature, and pressure of the reactant gas feed streams and allow a control system to provide “real time” feedback of pressure- and temperature-compensated flow rates to operators and/or control devices may be used.

As will be appreciated by one skilled in the art, the foregoing functions and/or process may be embodied as a system, method or computer program product. For example, the functions and/or process may be implemented as computer-executable program instructions recorded in a computer-readable storage device that, when retrieved and executed by a computer processor, controls the computing system to perform the functions and/or process of embodiments described herein. In one embodiment, the computer system can include one or more central processing units, computer memories (e.g., read-only memory, random access memory), and data storage devices (e.g., a hard disk drive). The computer-executable instructions can be encoded using any suitable computer programming language (e.g., C++, JAVA, etc.). Accordingly, aspects of the present invention may take the form of an entirely software embodiment (including firmware, resident software, micro-code, etc.) or an embodiment combining software and hardware aspects.

In one embodiment, when mixing the reactant gases, it is desirable to avoid side reactions in the mixing vessel. The side reactions may include oxidation of the methane or ammonia. The deflagration or risk and impact of a detonation under adverse operating conditions should also be avoided in the mixing vessel by maintaining a flow velocity in the mixing vessel that is greater than the flamefront of the ternary gas. The term “deflagration” as used herein refers to a combustion wave propagating at subsonic velocity relative to the unburned gas immediately ahead of the flame. “Detonation” refers to a combustion wave propagating at supersonic velocity relative to the unburned gas immediately ahead of the flame. Deflagrations typically result in modest pressure rise whereas detonations can lead to extraordinary pressure rise. The present invention provides an advantageous solution to quickly and thoroughly mix the reactant gases while minimizing the pressure drop during mixing and avoiding unwanted side reactions such as oxidation and deflagration.

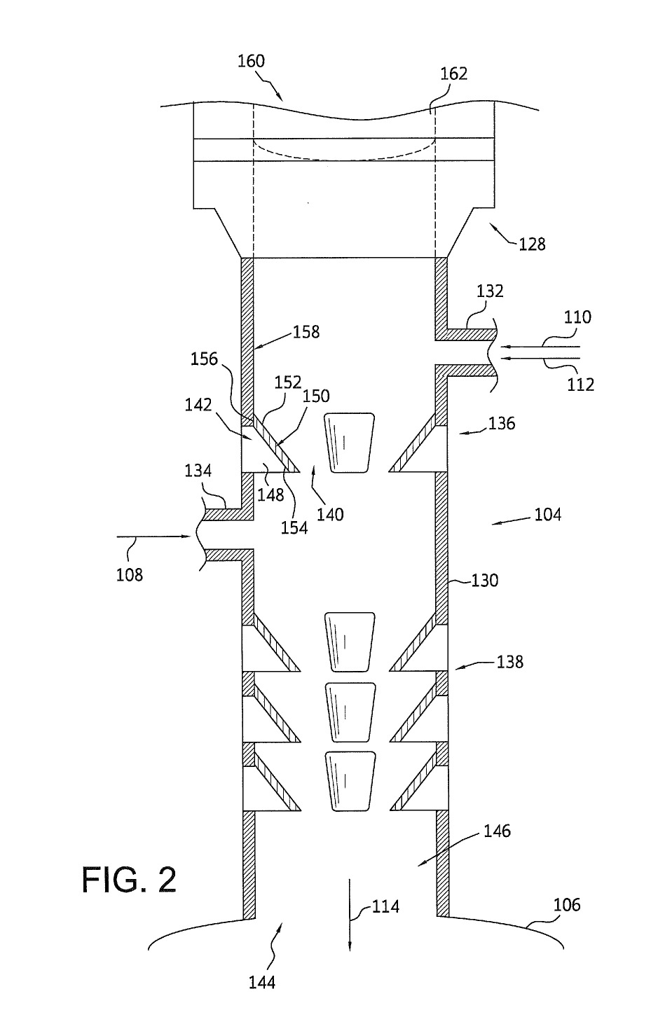

In FIG. 2, there is shown a cross-section view of a mixing vessel 104. Mixing vessel 104 produces a ternary gas mixture 114 having a CoV of less than 0.1 that exits through the proximal end, e.g. downstream end, and into HCN reactor vessel 106. At a distal end, e.g., upstream end, of mixing vessel 104, there is provided a pressure relief regulator 128, which is more fully discussed herein. Mixing vessel 104 comprises an elongated conduit 130 that may extend into the reactor vessel in the flow direction of the ternary gas. In one embodiment, there is a first inlet port 132, also referred to as an upper inlet, for introducing at least one reactant gas selected from the group consisting of a methane-containing gas, an ammonia-containing gas, an oxygen-containing gas, and mixtures thereof. Preferably, a methane-containing gas 110 and an ammonia-containing gas 112 are introduced through first inlet port 132. Additional reactant gases may also be introduced into conduit 130 through a second inlet port 134, also referred to as a lower inlet. In one embodiment, the reactant gas introduced through second inlet port 134 may be selected from the group consisting of a methane-containing gas, an ammonia-containing gas, an oxygen-containing gas, and mixtures thereof. Preferably, an oxygen-containing gas stream 108 may be introduced through second inlet port 134. As shown in FIG. 2, second inlet port 134 is proximal to the first inlet port 132. Because the ternary gas mixture is not formed until the oxygen-containing gas is introduced, it is preferred to introduce oxygen-containing gas stream 108 lower in conduit 130 to reduce the volume of the ternary gas mixture.

Elongated conduit 130 further comprises one or more static mixing zones for producing a thoroughly mixed ternary gas. In one embodiment, there is at least one static mixing zone 136 that is located adjacent to first inlet port 132. Static mixing zone 136 provides for mixing of methane-containing gas 110 and ammonia-containing gas 112 prior to being mixed with oxygen-containing gas 108. Static mixing zone 136 may form a binary gas of methane and ammonia. There is also at least one static mixing zone 138 that is located adjacent to or proximal to second inlet port 134. Static mixing zone 138 mixes the oxygen-containing gas with the other reactant gases to produce the ternary gas mixture. In particular, static mixing zone 138 should be installed as close as is practical to the reactor catalyst bed (not shown) in reactor vessel 106 so that the volume and the residence time of the ternary gas mixture in the mixing vessel 104 are minimized.

Although one inlet is shown for ports 132 and 134 in FIG. 2, in one embodiment there may be a plurality of first inlet ports and second inlet ports. There may be multiple feed entries around the entire circumference of elongated conduit 130. Each of the feed entries may be at an angle of 5 to 90° to the flow direction of the ternary gas mixture. The main feed line of reactants may be connected to an annular zone (not shown) surrounding the plurality of first inlet ports and/or second inlet ports. There may be a plurality of holes (not shown) that defines the inlet port and provides a feed entry from the annular zone into elongated conduit 130. Without being bound by theory, the plurality of holes may prevent rotation, i.e. swirling, when the reactants are fed to mixing vessel 104.

In another embodiment, first inlet port(s) 132 and second inlet port(s) 136 may extend into the cavity of elongated conduit 130. This may allow the reactants to be introduced into the middle of elongated conduit 130. Without being bound by theory the extended inlet may prevent the reactants from passing through mixing vessel 104 without contacting tabs 150. Preferably the second inlet port 138, which feeds oxygen-containing gas 108, is extended into the middle of conduit 130.

Static mixing zones 136 and 138 each comprise one or more rows 140 of non-continuous slots 142. Each static mixing zone 136 and 138 may comprise from one to ten rows of non-continuous slots 142. In one embodiment, the number of rows in second static mixing zone 138 may be greater than or equal to the number of rows in first static mixing zone 136. For example, second static mixing zone 138 may have from one to three rows. Each row 140 may comprise from one to ten non-continuous slots 142, and it is preferred to include from two to six non-continuous slots 142. Within each row 140, non-continuous slots 142 are preferably evenly spaced and are non-continuous around the circumference of conduit 130. As the number of rows and/or number of tabs 150 in each row increase, the pressure drop in mixing vessel 104 would also increase. Thus, it is desirable to use a combination of rows and tabs that provides thorough mixing while maintaining a pressure drop of less than 35 kPa. In one aspect, the total number of non-continuous slots 142, and thus tabs 150, for the mixing vessel may be from 4 to 24, e.g., from 8 to 20 or from 10 to 16.

Proximal to second static mixing zone 138 and before outlet 144 of mixing vessel 104, there may be an empty space 146. Empty space 146 allows a non-mixing area for the ternary gas mixture. Empty space 146 may have a height that is from 0.1*d to 10*d, wherein d is the internal diameter of elongated conduit 130.

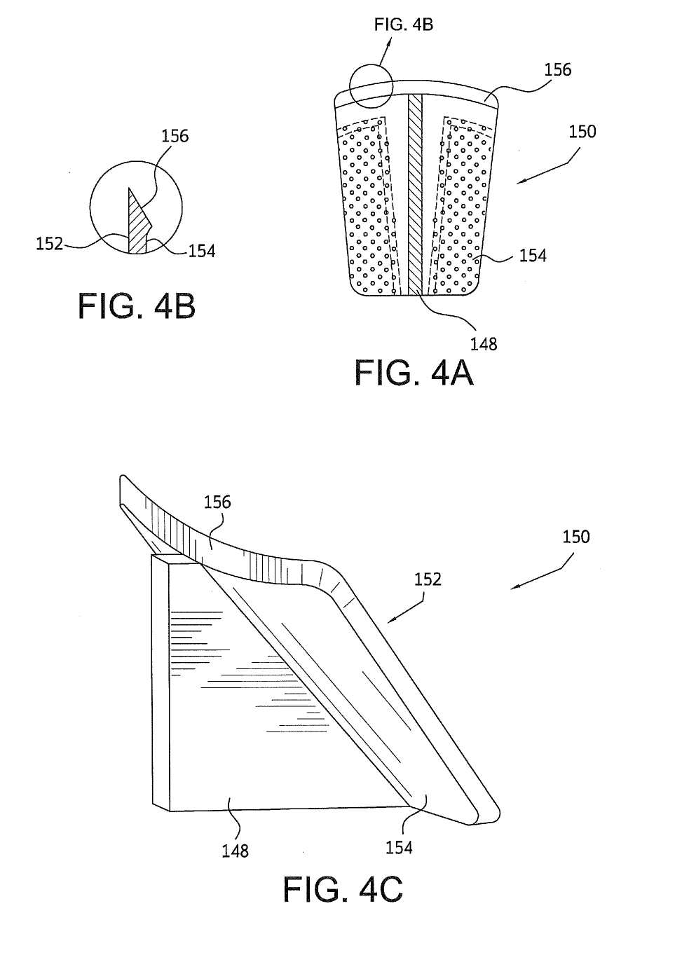

In one embodiment, non-continuous slot 142 may be aligned with the flow direction of the ternary gas or may be in an I-shape, I-shape, T-shape, U-shape, or V-shape. As shown in FIGS. 4A-4C, support 148 is a bar, e.g., I-shape or I-shape, and extends past the plane of the upstream surface 152. In other embodiments, when each tab 150 has more than one support 148, a V-shape or U-shape non-continuous slot 142 may be used.

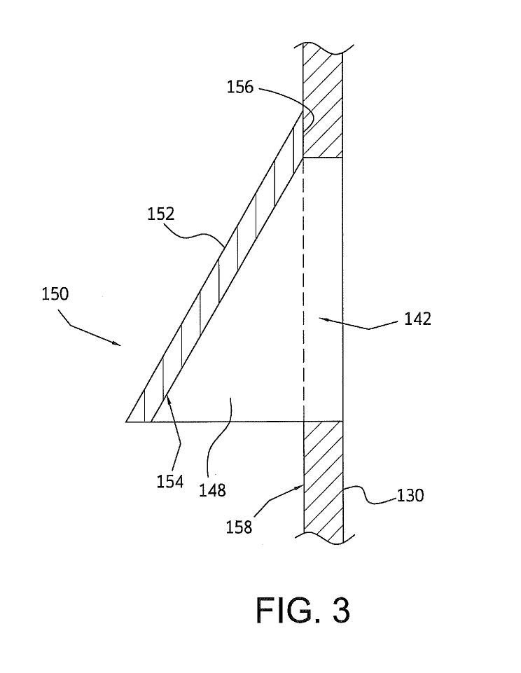

Tab 150 comprises a bevel edge 156, as shown in FIG. 4B, that extends above non-continuous slots 142 and abuts against internal wall 158 of elongated conduit 130 as shown in FIG. 3. Bevel edge 156 may also extend above support 148. Preferably, bevel edge 156 does not contact tabs 150 of another adjacent row 140. The angle of bevel edge 156 may be determined by the angle of upstream surface 152.

Tabs 150 may be constructed of stainless steel materials such as 310SS and 316SS.

Support 148 may provide rigidity to tab 150 so that tab 150 does not deform under pressure change. Due to the non-continuous slots 142 and tab 150 arrangement, and the lack of an adhesive or weld on the internal surface of elongated conduit 130, tabs 150 may have a rigidity to retain an angle upon a pressure change in elongated conduit 130. When there is a change of pressure within elongated conduit 130, the tabs may be stronger than bend fillet-weld mixing tabs that is surface welded to the inside of conduit 130. For purposes of the present invention, tabs are not deformed under pressure changes of more than 5 MPa, e.g., preferably more than 13 MPa. Once the pressure conditions are restored to normal operating conditions, the tabs retain their original angle. Thus, mixing vessel 104 does not suffer a decrease in mixing efficiency under such pressure changes.

Non-continuous slot 142 is an opening through conduit 130 in which no reactant gases are fed. Non-continuous slot 142 may be machined into conduit 130. A tab 150 is inserted through the non-continuous slot 142 and tab 150 extends into the cavity of conduit 130. Support 148, which extends past the plane of the upstream surface, slidably engages into the non-continuous slot 142 from the internal cavity of elongated conduit 130. Tab 150 may be referred to as a through-cut mixing tab. Tab 150 is secured to the external wall of conduit 130. It is preferred that once tab 150 is inserted, tab 150 is secured by an adhesive or weld from the outside of conduit 130. Once tab 150 is secured, there is no leakage of gases through the non-continuous slot 142. This greatly increases the efficiency and accuracy of positioning tabs 150 within conduit 130 as opposed to an internal weld that is difficult to properly align and secure. In addition, this allows for easy insertion of tabs by allowing one to work from the outside of the conduit rather than from within the conduit.

When positioning the rows of each static mixing zone, a chamfer may be ground out on the external surface of conduit and a non-continuous slot is made through the chamfer. Once tab 150 is inserted, the chamfer may be filled with the welding metal to secure tab 150. The tab 150 may be inserted from the inside of conduit and the tab 150 and support 148 may extend through the conduit so as to externally secure the tab 150.

In one embodiment, tab 150 has an upstream surface 152 that is angled in the flow direction. The angle of tab 150 is measured from the internal wall of the conduit. The angle may vary from 5° to 45°, and more preferably from 20° to 35°. Downstream surface 154 may have a similar angle as upstream surface. The tabs within a row may have a substantially similar angle, e.g. within ±5°. The angle in the tabs between adjacent rows may vary, as well as between the different mixing zones. In mixing zones with multiple rows, the downstream row may have tabs with an angle that is less than the angle of the tabs in the upstream rows. In one exemplary embodiment, first mixing zone 136 may have tabs with an angle of 30° and second mixing zone 138 may have tabs with an angle of 25°. In another exemplary embodiment, first mixing zone 136 may have tabs with an angle of 30° and second mixing zone 138 may have tabs with an angle of 45°. The surface area upstream of surface 152 of each tab 150 is limited to prevent increased pressure drop and generally may range from 50 to 250 cm², e.g., from 75 to 150 cm², depending on the number of tabs and rows. As the total surface area of all the tabs 150 increases, the pressure drop may also increase.

In addition, tabs 150 lack cant, i.e. are not twisted, and are aligned on the internal wall of conduit 130 to be substantially parallel to the flow of the ternary gas mixture. In one embodiment, the cant of tabs 150 is from 0° to 7°, e.g., from 0° to 3°. Having a slight cant of greater than 8° may result in poor mixing performance that may lead to increases in bed temperature variations and/or undesirable pressure drop increases. Thus, the through-cut non-continuous slots of the present invention allow for a tab having a reduced cant and improved performance in reducing the bed temperature variations. In one embodiment, the bed temperature variation may be from 15° C. to 25° C. across the bed.

Under a pressure upset in the reactor, tabs 150 are positioned within the through-cuts to withstand twisting and do not deform under pressure upsets. This avoids costly delays for repairs. If there is any damage, the damaged tab may be easily removed and replaced with a new tab by inserting it through the non-continuous slot and welding from the external surface of elongated conduit.

In addition, tabs within a static mixing zone may have a substantially similar angle. Different angles may be used for different rows and tabs in different static mixing zones. In an exemplary embodiment, the tabs in the first static mixing zone 136 have an angle that is different from the angle of the tabs within the second static mixing zone 138. Increasing the angle may achieve increased mixing but with a corresponding undesirable increase in the pressure drop. Each of the tabs 150 within the elongated conduit 130 are non-parallel to the flow direction. In other words, within the cavity of conduit 130, tab 150 does not have a surface that is substantially parallel to the walls of conduit 130. The supports 148 may be substantially parallel to the flow direction, but the supports 148 are located on the downstream surface 154 and do not have a significant impact on the mixing. Instead, tabs 150 and supports 148 are inserted through non-continuous slots 142 and tabs 150 are secured to an external wall of conduit 130. Along the external wall of conduit 130, tabs 150 may have a surface that is substantially parallel to the external wall.

Each tab 150 may have a suitable thickness from 0.1 to 2.5 cm, e.g., from 0.5 cm to 1.5 cm, to maintain rigidity of tab 150. The trailing edge of the tab is the edge of the tab that extends furthest from the internal wall of the conduit into the mixing area. The trailing edge of the tab may be rounded, tapered or squared as needed to provide the necessary mixing. In one embodiment, the trailing edge of the tab may be sharp, such as a knife edge, having an angle from 30° to 90°, e.g., 45° to 90°. The sharp edge may provide for increased mixing within mixing vessel 104. A blunt edge that has an angle of less than 30° may undesirably increase pressure drop within mixing vessel.

Tabs 150 within conduit 130 operate as fluid foils that, with reactant gases flowing through mixing vessel 104, have greater fluid pressures manifest against their upstream surfaces 152 and reduced fluid pressures against their downstream surfaces 154. This pressure difference in the fluid on adjacent, mutually opposed faces of each of the tabs 150, causes the longitudinal flow over and past each tab 150 to be redirected, thereby resulting in the addition of a radial cross-flow component to the longitudinal flow of fluid through the conduit 130. The fluid flow over the edges of each tab results in the flow being deflected inward and up by the angled upstream face to generate pairs of oppositely rotating predominantly streamwise vortices at the tips of each tab, and downstream hairpin vortices interconnecting adjacent streamwise vortices generated by a single tab. The vortices of each such pair have mutually opposed rotations, about an axis of rotation oriented generally along the longitudinal stream-wise fluid flow direction, along the annular space between the two boundary surfaces. The turbulent mixing generated by static mixing zones 136 and 138 produces a thoroughly mixed ternary gas mixture having a CoV of less than 0.1.

In one embodiment, when static mixing zones 136 and 138 comprise more than two rows 140, tabs 150 from each row may be transversely aligned with the adjacent row to achieve the desired mixing effect. Transversely offset tabs 150, i.e. “staggered,” may be used in some embodiments.

The shape of upstream surface 152 of the 150 may include trapezoid, square, parallelogram, semi-ellipsoid, rounded square, or rectangular. A tapered tab having a trapezoid shape may be used in one embodiment. In addition, tabs may be slightly bent or curved. In one embodiment, the lengthwise dimension of the tab, in the direction of the main streamwise flow, does not exceed twice the width of the tab.

The dimensions of mixing vessel 104 can vary widely and will be dependent, to a large degree, on the capacity of reactor vessel 106. In one exemplary embodiment of the invention disclosed herein, mixing vessel 104 has an outside length to diameter ratio in the range from 2 to 20, for example from 2 to 10. The size of mixing vessel may vary, but may have a length of 1 m to 5 m, e.g., from 1.2 to 2.5 m, and an internal diameter of 5 to 60 cm, e.g., from 10 to 35 cm.

Although there are two inlet ports and two static mixing zones shown in FIG. 2, in other embodiments there may be one inlet port having one static mixing zone. In addition, there may be two inlet ports having one static mixing zone located proximal to the lower inlet port. Other configurations of inlet ports and static mixers may be used within the scope of the present invention.

The ternary gas mixture 114 may pass from mixing vessel 104 into the inlet port of reactor vessel 106. In one embodiment, there may one or more distributor plates 120 for providing an evenly distributed ternary gas mixture on the catalyst bed. A flame arrester may also be used in combination with the distributor plates to distribute the ternary gas on the catalyst bed. Preferably, the distributor plate should not cause a pressure drop in the reactor vessel of greater than 35 kPa, e.g. more preferably a pressure drop of less than 25 kPa. In one aspect, there is one distributor plate disposed within the reactor vessel downstream of the inlet and upstream of the flame arrester. The distributor plate may have a diameter that is greater than the inlet port and less than a maximum diameter of the reactor vessel. The distributor plate has a void area, formed by one or more holes, that is at least 50% to 80% of the area of the distributor plate. The void area may have a raised, conical-shaped, feature on the upstream surface to diffuse the ternary gas mixture. The distributor plate may also comprise a solid area that is aligned, preferably concentrically aligned, with a centerpoint of the inlet port. In one embodiment, the distributor plate may be a wire mesh material.

The materials of construction for the mixing vessel and tabs may vary and can be any material compatible with the ternary gas mixture that is capable of withstanding design temperatures and pressures in the mixing vessel without significant degradation, and that does not promote reaction of the gases in the ternary gas mixture. Satisfactory results have been obtained using stainless steel materials of construction including 310SS and 316SS.

In one embodiment, catalytic activity of the mixer's interior surfaces is reduced by polishing those surfaces exposed to gas flow to reduce the specific surface area (roughness) of the interior surfaces. For example, machining the internal diameter of the mixing vessel to a surface roughness (rms) of about 125 microinches (3.2 micrometers) significantly reduces the catalytic activity.

Mixing vessel 104 may be provided with one or more suitable analyzers for measuring the concentration of methane and ammonia exiting first static mixing zone 136 and/or second static mixing zone 138. Such on-line and off-line analyzers are well known in the art. Nonlimiting examples of such analyzers include infrared analyzers, Fourier transform infrared analyzers, gas chromatography analyzers, and mass spectrometry analyzers. Likewise, second static mixing zone 138 may be provided with one or more suitable analyzers for measuring the oxygen concentration in the ternary gas mixture.

In an optional embodiment not shown in FIG. 2, upper and lower inlets 132 and 134 are provided with inert gas connections with automatic valves so that the lines to mixing vessel 104 can be purged of reactants when necessary, such as for maintenance shutdowns or reactor shutdowns.

In one embodiment, mixing vessel 104 may also comprise one or more flow straighteners (not shown). Flow straighteners may have a configuration to align the flow prior to the gas feed streams contacting a static mixing zone. Also, flow straighteners maintain a substantially uniform velocity profile across the flow straightener. Flow straighteners may also distribute the gas around the entire area of conduit 130 and prevent the reactant gases from passing directly down the middle of mixing vessel 104.

Flow straighteners, when used, may be positioned proximal, e.g., downstream, to the first inlet port 132 and/or second inlet port 134. Preferably, the flow straighteners are located directly upstream of the first row of tabs in the first static mixing zone 136 and upstream of second static mixing zone 138, respectively.

In one embodiment, flow straighteners may have a plurality of radial plates that connect in the middle. Some flow straighteners may have a center body in the middle to prevent the reactant gases from passing down through the middle of the elongated conduit. The center body may be conical-shaped or pyramidal-shaped. The center body is typically positioned to at least partially overlap with the centerline of the mixing vessel. The center body advantageously improves mixing by denying flow through the middle of the mixing vessel and forces the ternary gas mixture to contact the tabs extending from the internal walls. The mixing of the ternary gas mixture in each static mixing zone may be improved when the gases are prevented from passing through the middle of the mixing vessel.

An emergency pressure relief regulator 128, such as a rupture disk, can be installed in a vent line 160 of mixing vessel 104. The pressure relief regulator 128 limits the pressure in the elongated conduit 130, and hence the total mass and potential energy contained between the first static mixing zone 136 and the catalyst bed (not shown), thereby reducing the impact of a deflagration or risk and impact of a detonation under adverse operating conditions. In one embodiment, the pressure relief regulator 128 has a pressure release setpoint from 110% to 115% of an operating pressure of mixing vessel 104.

Good results have been obtained when pressure relief regulator 128 is supported on a distal end of first static mixing zone 136 so as to be in communication with the vent line 160 that can extend to a stack 162. Thus, upon excess pressure buildup in mixing vessel 104, pressure relief regulator 128 opens and the heated gases are vented from reaction vessel 106 and mixing vessel 104. A nitrogen purge stream can be used to purge the vapor volume through pressure relief regulator 128.

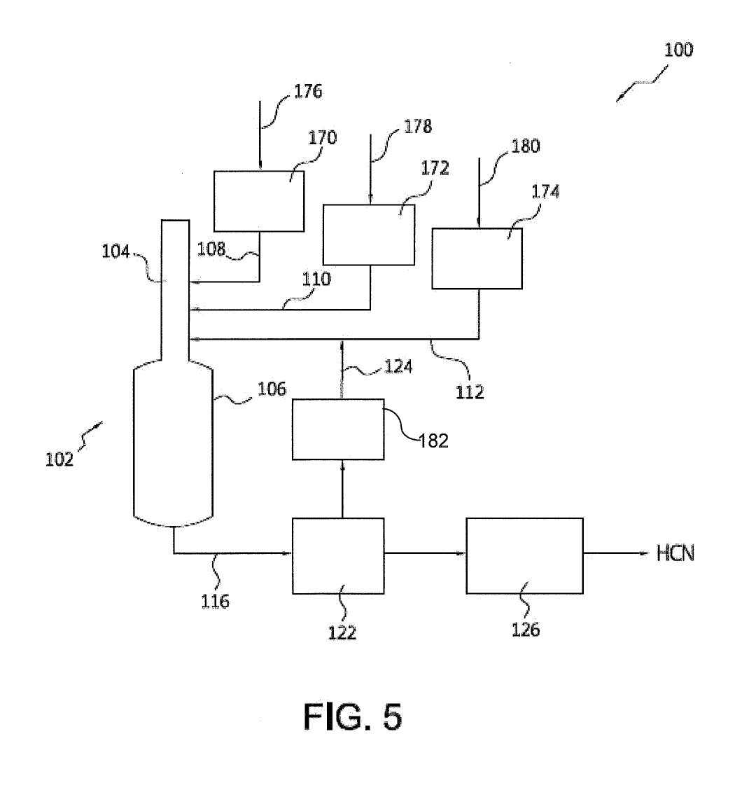

In the production of HCN, the reactant gases are each processed through suitable feed preparation systems 170, 172 and 174, respectively, as shown in FIG. 5. The source of the respective reactant gases may be delivered to each respective feed preparation system via any suitable delivery system known in the art, such as pipeline, truck, boat, or rail, and the like.

As shown in FIG. 5, the oxygen-containing source 176 can be supplied from the oxygen feed preparation system 170 that includes equipment to regulate the pressure of the oxygen-containing source 176 introduced into the process, and a filter to remove fine particles from an unfiltered oxygen-containing source 176. Increasing the oxygen content of the oxygen-containing source 176 can be advantageous for increasing the reaction yield and reducing the size of process equipment. Increasing the oxygen content of air also increases the flammability of substances normally flammable in air. Entrained metallic particles (such as iron or steel) and/or other contaminants and by-products in the feed stream can cause oxygen piping fires if not removed. Any suitable mechanism can be used for removal of the entrained metallic particles and other contaminants from the unfiltered oxygen-containing source 176, such as, for example, filtration, cyclone separators, coalescers, demisters, and mist eliminators. When the source of oxygen-containing feed gas requires compression, use of oil-free compressors and seal designs known to those skilled in the art can also lessen contamination. For oxygen-enriched air, a compressor may be needed.

The term “air” as used herein refers to a mixture of gases with a composition approximately identical to the native composition of gases taken from the atmosphere, generally at ground level. In some examples, air is taken from the ambient surroundings. Air has a composition that includes approximately 78 vol. % nitrogen, approximately 21 vol. % oxygen, approximately 1 vol. % argon, and approximately 0.04 vol. % carbon dioxide, as well as small amounts of other gases.

The term “oxygen enriched air” as used herein refers to a mixture of gases with a composition comprising more oxygen than is present in air. Oxygen enriched air has a composition including greater than 21 vol. % oxygen, less than 78 vol. % nitrogen, less than 1 vol. % argon and less than 0.04 vol. % carbon dioxide. In some embodiments, oxygen-enriched air comprises at least 28 vol. % oxygen, e.g., at least 80 vol. % oxygen, at least 95 vol. % oxygen, or at least 99 vol. % oxygen.

Using a high oxygen concentration in the oxygen-containing source 176 (i.e., low concentration of inerts such as nitrogen) offers the opportunity to reduce the size and operating cost of downstream equipment that would otherwise be necessary to process a large volume of inert nitrogen. In one embodiment, the oxygen-containing gas comprises greater than 21 vol. % oxygen, e.g. greater than 28 vol. % oxygen, greater than 80 vol. %, greater than 90 vol. %, greater than 95 vol. % or greater than 99 vol. % oxygen. For purposes of clarity herein, whenever the term “oxygen-enriched air” is used, the term is intended to encompass an oxygen content of greater than 21 vol. % up to and including 100 vol. %, i.e., pure oxygen. Whenever the term “oxygen-containing gas feed stream” is used, the term is intended to encompass an oxygen content of 21 vol. % up to and including 100 vol. %, i.e., pure oxygen.

The purity of the methane-containing source 178 may be more carefully controlled as the oxygen content of the oxygen-containing source 176 increases. As would be understood by one of ordinary skill in the art, the source of the methane may vary and may be obtained from renewable sources such as landfills, farms, biogas from fermentation, or from fossil fuels such as natural gas, oil accompanying gases, coal gas, and gas hydrates as further described in VN Parmon, “Source of Methane for Sustainable Development”, pages 273-284, and in Derouane, eds. Sustainable Strategies for the Upgrading of Natural Gas: Fundamentals, Challenges, and Opportunities (2003). For purposes of the present invention, the methane purity and the consistent composition of the methane-containing source 178 is of significance. The methane may be delivered to the HCN synthesis system 100 in a purified state, in a semi-purified state, or in an impure state.

Natural gas, for example, is an impure state of methane. That is, natural gas is a substantially methane-containing gas that can be used to provide the carbon element of the HCN produced in the process of the present invention. However, in addition to methane, natural gas may contain contaminants such as hydrogen sulfide, carbon dioxide, nitrogen, water and higher molecular weight hydrocarbons, such as ethane, propane, butane, pentane, etc., all of which are, when present, detrimental to the production of HCN. Natural gas composition can vary significantly from source to source. The composition of natural gas provided by pipeline can also change significantly over time and even over short time spans as sources are taken on and off of the pipeline. Such variation in composition leads to a difficulty in sustaining optimum and stable process performance. The sensitivity of the HCN synthesis process to these variations becomes more severe as inert loading is reduced through oxygen enrichment of the oxygen-containing source 176.

Referring to FIG. 5, the methane-containing source 178 can be supplied from a methane feed preparation system 172 that includes equipment to concentrate the methane, remove higher molecular weight hydrocarbons, carbon dioxide, hydrogen sulfide and water from the natural gas, and filter the natural gas to remove fine particles. Purification of, for example, the natural gas provides a methane-containing gas feed stream 110 highly concentrated in methane and with greatly reduced variability in the composition and fuel value. The purified methane-containing gas 110, when mixed with the oxygen-containing gas 108 and ammonia-containing gas 112, provides the ternary gas mixture that reacts more predictably during the synthesis of HCN compared to use of an unpurified methane-containing gas feed stream. More consistent purification and control of the methane-containing gas stabilizes the process and allows determination and control of optimum molar ratios of methane/oxygen and ammonia/oxygen which, in turn, leads to a higher yield of HCN.

Using purified natural gas to obtain the methane-containing gas feed stream 110, i.e., one containing substantially pure methane, to produce HCN also increases the catalyst life and yield of HCN. In particular, using the substantially pure methane-containing gas 110: (1) reduces the concentration of impurities, such as sulfur, CO₂, and H₂O, that have either a detrimental effect downstream or have no process benefit; (2) stabilizes the remaining composition at a consistent level to (a) allow downstream HCN synthesis to be optimized, and (b) enables the use of highly enriched or pure oxygen-containing gases by mitigating large temperature excursions in the HCN synthesis step that are typically related to variation in higher hydrocarbon content and are detrimental to optimum yield and operability (such as catalyst damage, interlock, and loss of uptime), and; (3) reduces higher hydrocarbons (i.e., C₂ and higher hydrocarbons) to minimize formation of higher nitriles such as acetonitrile, acrylonitrile, and propionitrile in the synthesis reaction, and the associated yield losses of HCN during removal of nitriles.

In addition, use of the substantially pure methane-containing gas 110 (1) eliminates or minimizes variability in the feed stock (i.e., it stabilizes the carbon and hydrogen content as well as the fuel values) and thereby stabilizes the entire HCN synthesis system 100 allowing for the determination and control of optimum methane-to-oxygen and ammonia-to-oxygen molar ratios for stable operation and the most efficient HCN yield; (2) eliminates or minimizes related temperature spikes and resulting catalyst damage; and (3) minimizes carbon dioxide thereby reducing the amount of carbon dioxide found in an ammonia recovery process and in a recovered or recycled ammonia stream coming from an ammonia recovery process, that may be downstream of reactor vessel 106. Eliminating or minimizing the carbon dioxide in such an ammonia recovery process and in a recovered or recycled ammonia stream reduces the potential for carbamate formation that causes plugging and/or fouling of the piping and other process apparatuses.

Prior to being mixed in mixing vessel 104 with oxygen-containing gas 108 and methane-containing gas 110, a “make up” or fresh ammonia stream 180 is processed through the fresh ammonia feed preparation system 174. Generally, the primary function of the fresh ammonia feed preparation system 174 is to remove contaminants, such as water, oil, and iron, from the fresh ammonia stream 180 prior to introduction of the ammonia-containing gas 112 into the mixing vessel 104. Contaminants in the ammonia-containing gas 112 can reduce catalyst life that results in poor reaction yields. The fresh ammonia feed preparation system 174 can include process equipment, such as vaporizers, and filters for the “make up” or fresh ammonia stream 180 to provide a treated fresh ammonia stream 112.

For example, commercially available liquid ammonia can be processed in a vaporizer to provide a partially purified ammonia vapor stream and a first liquid stream containing water, iron, iron particulate and other nonvolatile impurities. An ammonia separator, such as an ammonia demister, can be used to separate the impurities and any liquid present in the partially purified ammonia vapor stream to produce the treated fresh ammonia stream (a substantially pure ammonia vapor stream) and a second liquid stream containing entrained impurities and any liquid ammonia present in the partially purified ammonia vapor stream.

In one embodiment, the first liquid stream containing water, iron, iron particulate and other nonvolatile impurities is fed to a second vaporizer where a portion of the liquid stream is vaporized to create a second partially purified ammonia vapor stream and a second, more concentrated, liquid stream containing water, iron, iron particulate and other nonvolatile impurities that can be further treated as a purge or waste stream. The second partially purified ammonia vapor stream can be fed to the ammonia separator. In another embodiment, the second, more concentrated, liquid stream containing water, iron, iron particulate and other nonvolatile impurities is fed to a third vaporizer to further reduce the ammonia content before treating as a purge or waste stream.

Foaming in the vaporizers can limit the vaporization rate of ammonia and decrease the purity of the ammonia vapor produced. Foaming is generally retarded by the introduction of an antifoaming agent into the vaporizers directly or into the vaporizer feed streams. The antifoaming agents belong to a broad class of polymeric materials and solutions that are capable of eliminating or significantly reducing the ability of a liquid and/or liquid and gas mixture to foam. Antifoaming agents inhibit the formation of bubbles in an agitated liquid by reducing the surface tension of the solutions. Examples of antifoaming agents include silicones, organic phosphates, and alcohols. In one embodiment, a sufficient amount of antifoaming agent is added to the fresh ammonia stream to maintain an antifoaming agent concentration in the range from 2 mpm to 20 mpm in the fresh ammonia stream 180. A nonlimiting example of an antifoaming agent is UNICHEM 7923 manufactured by Unichem of Hobbs, N. Mex.

The fresh ammonia feed preparation system 174 may also be provided with a filter system for removing micro particulates from the treated fresh ammonia stream 180 to prevent poisoning of the catalyst in reactor vessel 106. The filter system can be a single filter or a plurality of filters.

Ammonia is also separated and recovered in the ammonia recovery section 112 as recycle ammonia stream 124 that can be separately treated in a recycle ammonia feed preparation system 182. The recycle ammonia feed preparation system 182 can include process equipment for filtering and heating the recycle ammonia stream 182 to produce a treated recycle ammonia stream 124. Heating the piping carrying recycle ammonia stream 124 helps prevent deposition on the inside piping walls. The treated recycle ammonia stream 124 can be combined with the treated fresh ammonia stream 112.

The HCN synthesis reaction that occurs in reaction vessel 106 is an exothermic reaction conducted at a reaction temperature in the range of 1000° C. to 1250° C. and a pressure in the range of 100 kPa to 400 kPa. The catalyst is typically a wire mesh platinum/rhodium alloy or a wire mesh platinum/iridium alloy. In one aspect, a 85/15 platinum/rhodium alloy may be used on a flat catalyst support. A 90/10 platinum/rhodium alloy may be used with a corrugated support that has an increased surface area as compared to the flat catalyst support. Other catalyst compositions can be used and include, but are not limited to, a platinum group metal, platinum group metal alloy, supported platinum group metal or supported platinum group metal alloy. Other catalyst configurations can also be used and include, but are not limited to, porous structures, wire gauze, tablets, pellets, monoliths, foams, impregnated coatings, and wash coatings. Catalyst is loaded in a reaction vessel to a catalyst loading in the range from 0.7 to 1.4 (g catalyst)/(kg feed gas/hr). The ternary gas mixture is contacted with the catalyst in the reaction vessel to provide a reaction product containing hydrogen cyanide, e.g., a crude hydrogen cyanide product.

In one embodiment, the catalyst bed, which is capable of converting the heated ternary gas into HCN, is supported by a support assembly formed of a material capable of reducing platinum-silicide formation and optimizing thermal stress resistance and fouling of tubes of the reactor. The catalyst support assembly is disposed substantially adjacent the catalyst bed. A flame arrester is spatially disposed above the catalyst bed so as to provide a space therebetween. The flame arrester quenches any upstream burning resulting from flash back within the internal reaction chamber. Ceramic foam is disposed along at least a portion of an interior wall of the housing defining the internal reaction chamber and the catalyst. The ceramic foam minimizes feed gas bypass due to catalyst shrinkage when the reactor is shut down. Ceramic foam disposed above the catalyst bed functions to minimize ternary gas volume, reduce pressure drop and quench formation of radicals during operation of the reactor. Ferrules are disposed in each of the outlets of the housing and provide fluid communication between the catalyst bed and an upper portion of a waste heat boiler. An undersupport having a substantially honeycomb configuration to reduce pressure drop across the undersupport is disposed substantially adjacent a lower surface of the catalyst support.

The flame arrester can be made of any suitable material known in the art as long as the flame arrester is capable of performing any of the functions of: (1) quenching upstream burning in the event of a flashback from the catalyst bed; (2) acting as a flow distributor to assure an even flow across the catalyst bed and to eliminate areas of low gas velocity which could flashback; (3) acting as a space filler to reduce the volume of reactants in the reactor to minimize the potential energy therein; and/or provides thermal insulation between the hot catalyst bed and the ternary gas mixture in the upper portion of the reactor. The flame arrestor employed can be fabricated of a material that: (1) has minimal catalytic effect, (2) is thermally stable at temperatures employed in the manufacture of HCN, (3) will not decompose ammonia, and (4) will not initiate oxidation. Examples of materials which can be employed in the construction of the flame arrester are ceramic refractory materials in any suitable form, including but not limited to: ceramic pills, ceramic foams, ceramic fiber blankets, alumina-silica refractory, non-woven blankets, combinations thereof, and the like. Nonlimiting examples of suitable ceramic refractory material compositions include 90 wt. % alumina, 94 wt. % alumina, and 95 wt. % alumina. Additionally, when pills are used as a material in the construction of the flame arrester, the size and shape of the pills can be varied, provided the pills used in the flame arrester are capable of performing the above referenced functions.

It should be noted that the use of the flame arrester substantially reduces the potential for the heated ternary gas mixture to become detonable through transfer from deflagration to detonation. For example, if it is determined that the flame velocity of the ternary gas mixture at 304 kPa and 100° C. is 1.2 m/sec, then the superficial velocity of preheated ternary gas mixture through the flame arrester, e.g., a pill bed containing ⅜-inch (9.5 mm) diameter pills, should be substantially greater than 1.2 m/sec, thereby preventing a flame from progressing through the pill bed. While the size of the pills used in the pill bed can vary widely, the diameter of the pills is generally from ⅛ inch to ½ inch (3 mm to 13 mm) in size.

Characteristics of the flame arrester, for example the depth of the pill bed, are chosen such that the pressure drop of the preheated ternary gas mixture across the flame arrester is balanced against the increased velocity of the ternary gas mixture and the reduced open space between the flame arrester and the catalyst bed, thereby minimizing the energy potentially released in a deflagration without substantially compromising the backflow to the pressure relief device in the mixing vessel. In one embodiment, the depth of the pill bed is at least 0.4 m.

From the above description, it is clear that the present invention is well adapted to carry out the objects and to attain the advantages mentioned herein as well as those inherent in the presently provided disclosure. While preferred embodiments of the present invention have been described for purposes of this disclosure, it will be understood that changes may be made which will readily suggest themselves to those skilled in the art and which are accomplished within the spirit of the present invention.

The invention can be further understood by reference to the following examples.

### Example 1

As illustrated in FIG. 2, a plurality of tabs having an I-shape support are inserted through corresponding non-continuous slots on an elongated conduit to form one row of four tabs in a first static mixing zone and three rows of four tabs in a second static mixing zone to form the mixing vessel. The first static mixing zone is positioned between the inlet port of the methane and ammonia containing gas and the second static mixing zone is positioned between the inlet port of the oxygen-containing gas and outlet port. Each tab has an angle of 30°±1°, except for the bottom row in the second static mixing zone where the tabs have an angle of 25°±1°. Each tab has a surface area that is approximately 77.5 cm². Each tab is inserted from the inside of the elongated conduit and is welded to the external surface of the elongated conduit. Tabs from one row align with the adjacent rows and tabs from the first mixing zone align with tabs from the second mixing zone. The degree of cant of the tabs is from 0° to 3°. This forms an exemplary mixing vessel to produce a ternary gas mixture.

The mixing vessel also has a rupture disk installed in a vent line. A flow straightener having four radial plates and a center-body is positioned upstream of the first static mixing zone. A second flow straightener having four radial plates and a center-body is positioned upstream of the second static mixing zone and downstream of the inlet for the oxygen-containing gas.

### Comparative Example A

A comparison static mixer has the same number of tabs and row configuration as the exemplary mixing vessel in Example 1 except the tabs are welded to the internal surface of the elongated conduit. The comparison static mixer lacks non-continuous slots. The degree of cant of the tabs is greater than 8°, which leads to increased rotation in the static mixer and poor mixing.

### Example 2

Methane and ammonia-containing reactant gases are fed to the first static mixing zone and oxygen-containing reactant gas is fed to the second static mixing zone. The reactant gases are fed at an methane-to-oxygen molar ratio of 1.2 and an ammonia-to-oxygen molar ratio of 1:1.5 to produce a ternary gas mixture containing approximately 28.5 vol. % oxygen. The ternary gas mixture is then fed to a reactor vessel having a 85/15 platinum/rhodium catalyst on a flat catalyst bed. The reaction temperature is from 1000° C. to 1200° C. Using the exemplary mixing vessel of Example 1, the ternary gas mixture has a coefficient of variation (CoV) of less than 0.1 across the catalyst bed. The operating pressure of the static mixer may vary from 130 kPa to 400 kPa. In addition, pressure drop within the exemplary mixing vessel of Example 1 is less than 35 kPa.

### Example 3

Using the exemplary mixing vessel of Example 1 and under similar reaction conditions as Example 2, the catalyst bed has a bed temperature variation from 15° C. to 25° C. across the bed. This bed temperature variation would indicate a thoroughly mixed ternary gas mixture. In contrast, the static mixer of Comparative A, under similar reaction conditions as Example 2, produces a ternary gas mixture that would result in a bed temperature variation of 35 to 100° C. across the bed. Poor mixing of the static mixer of Comparative A may be attributed to the difficultly in aligning tabs by welding to the inside of elongated conduit.

### Example 4

Using the exemplary mixing vessel of Example 1 and under similar reaction conditions as Example 2, a reactor upset causes a dramatic pressure increase estimated to be greater 13 MPa that bursts through the rupture disk. The tabs in the exemplary mixing vessel of Example 1 withstand the pressure upset and do not deform. The tabs maintain their shape and the cant remains from 0° to 3°. In contrast, the tabs of the static mixer of Comparative A will not withstand the pressure upset and would deform. This requires replacing the damaged tabs and/or replacing the mixing vessel leading to downtime in the production of HCN.

### Example 5

The exemplary mixing vessel of Example 1 is tested to determine if there is any leakage of the oxygen-containing gas, the methane-containing gas, or the ammonia-containing gas through the sixteen non-continuous slots after the tabs are inserted and welded. The gases are fed to the mixing vessel and the mixing vessel is sealed and pressurized. A detector is used to determine if any gases are leaking from the mixing vessel. No leakage is observed.

### Example 6

A plurality of tabs having an I-shape support are inserted through corresponding non-continuous slots on an elongated conduit to form four rows of four tabs in a static mixing zone positioned between the inlet port of the oxygen-containing gas and outlet port. Unlike Example 1, there are no tabs positioned between the inlet port of the methane-containing gas and ammonia-containing gas. Each tab has an angle of 30°±1°, except for the bottom row where the tabs have an angle of 25°±1°. Each tab has a surface area that is approximately 77.5 cm². Each tab is inserted from the inside of the elongated conduit and is welded from the external surface of the elongated conduit. Tabs from one row align with the adjacent rows. The degree of cant of the tabs is from 0° to 3°. This forms an exemplary mixing vessel to produce a ternary gas mixture. Under the similar reaction conditions as Example 2, the CoV is higher than Example 2, indicating reduced mixing efficiencies.

1-15. (canceled)

16. A process for producing hydrogen cyanide, comprising:
introducing a methane-containing gas, an ammonia-containing gas, and an oxygen-containing gas into an elongated conduit to produce a ternary gas mixture, the elongated conduit comprising one or more static mixing zones having at least one non-continuous slot through which a tab is inserted and secured to an external surface of the elongated conduit; and
contacting the ternary gas mixture with a catalyst in a catalyst bed to provide a reaction product comprising hydrogen cyanide.

17. The process of claim 16, wherein the step of introducing comprises:
mixing the methane-containing gas and the ammonia-containing gas in a first static mixing zone comprising one or more first rows of the non-continuous slots to form a binary gas mixture; and
mixing the oxygen-containing gas with the binary gas mixture in a second static mixing zone to form the ternary gas mixture, wherein the second static mixing zone comprises one or more second rows of the non-continuous slots.

18. The process of claim 16, wherein the ternary gas mixture has a coefficient of variation of less than 0.1 across the diameter of the catalyst bed.

19. The process of claim 16, further comprising passing at least the methane-containing gas and the ammonia-containing gas across a flow straightener prior to the one or more static mixing zones, wherein the flow straightener has a center body.

20. The process of claim 16, wherein the tab, once inserted, has an angle from an internal wall of the elongated conduit that is from 5° to 45°.

21. The process of claim 16, wherein the elongated conduit has from 4 to 24 non-continuous slots.

22. The process of claim 21, wherein the non-continuous slots are in I-shape, I-shape, T-shape, U-shape, or V-shape.

23. The process of claim 16, wherein the tab is secured to the non-continuous slot by a weld joint formed on the external surface of the elongated conduit.

24. The process of claim 16, wherein a pressure drop in the elongated conduit is less than 35 kPa.

25. The process of claim 16, wherein the tab has a degree of cant from 0° to 7°.

26. The process of claim 16, wherein the tab has a rigidity to retain an angle upon a pressure change in the elongated conduit.

27. The process of claim 16, wherein the ternary gas mixture comprises at least 25 vol. % oxygen.

28. The process of claim 16, wherein the ternary gas mixture has a molar ratio of ammonia-to-oxygen from 1.2 to 1.6 and a molar ratio of methane-to-oxygen from 1 to 1.25.

29. The process of claim 16, wherein the mixing vessel operates at a temperature from 50° C. to 120° C.

30. The process of claim 16, wherein there is no weld or adhesive provided from the internal cavity to secure the tab.

31. A reaction assembly for preparing hydrogen cyanide comprising:
(a) a mixing vessel comprising an elongated conduit having
an outlet located at a proximal end of the elongated conduit,
a first inlet port and a second inlet port each for introducing at least one reactant gas selected from the group consisting of a methane-containing gas, an ammonia-containing gas, an oxygen-containing gas, and mixtures thereof, into the mixing vessel, wherein the second inlet port is downstream of the first inlet port,
a first static mixing zone comprising one or more first rows of non-continuous slots through which one or more corresponding tabs are inserted and secured to an external surface of the elongated conduit, and wherein the first static mixing zone is adjacent to the first inlet port,
a second static mixing zone comprising one or more second rows of non-continuous slots through which one or more corresponding tabs are inserted and secured to the external surface of the elongated conduit, and wherein the second static mixing zone is adjacent to the second inlet port,
wherein each corresponding tab has an upstream face that is angled in the flow direction,
wherein the first and second static mixing zones provide cross-stream mixing of the at least one reactant gas to produce a ternary gas; and
(b) a reactor vessel comprising a reactor inlet that is operatively coupled to the outlet to receive the ternary gas mixture, and a catalyst bed containing a catalyst for producing a hydrogen cyanide stream.

32. A process for manufacturing a mixing vessel comprising:
providing one or more tabs having an angled upstream surface having a bevel edge, downstream surface, and a support on the downstream surface, wherein the support has a shape that is selected from the group consisting of an I-shape, I-shape, T-shape, U-shape, and V-shape and extends past the plane of the upstream surface; and
providing an elongated conduit having an internal cavity, a first inlet port, and an outlet port that is connected to a reactor vessel.

33. The process of claim 32, further comprising:
cutting one or more non-continuous slots through the elongated conduit downstream of the first inlet port, wherein the non-continuous slots correspond to the shape of the support;
inserting one of the one or more tabs into one of the one or more non-continuous slots from the internal cavity by slidably engaging the support into the non-continuous slots and abutting the bevel edge against the internal surface of the elongated conduit upstream of the one or more non-continuous slots; and
securing the support to the outer surface of the elongated conduit.

34. The process of claim 32, wherein the support is secured by welding to the outer surface.

35. The process of claim 32, wherein a chamfer is ground out on the outer surface of the elongated conduit where the one or more non-continuous slots are cut.

36. The process of claim 32, wherein there is no weld or adhesive provided from the internal cavity to secure the one or more tabs.
